(19) United States
(12) Patent Application Publication
(10) Pub. No.: US 2019/0041649 A1
(43) Pub. Date: Feb. 7, 2019

(54) DISPLAY SYSTEM, INFORMATION PROCESSOR, INFORMATION PROCESSING METHOD AND PROGRAM

(71) Applicant: NS SOLUTIONS CORPORATION, Tokyo (JP)

(72) Inventor: Kazuyoshi INOUE, Tokyo (JP)

(21) Appl. No.: 16/074,646

(22) PCT Filed: Feb. 22, 2017
(86) PCT No.: PCT/JP2017/006541

§ 371 Date: Aug. 1, 2018

(30) Foreign Application Priority Data
Mar. 4, 2016 (JP) 2016-042249

(51) Int. Cl. G02B 27/01; H04N 5/225; G06F 3/01

(52) U.S. Cl. CPC G02B 27/0172; G02B 2027/0178; G06F 3/011; H04N 5/225

(57) ABSTRACT

The problem is solved by a display system including: a teaching image acquirer that acquires a registered teaching image for work; a displayer that displays the teaching image for the work acquired by the teaching image acquirer on a display unit of a display device worn by a worker who performs the work to display the image for the work superimposed on a real space; a captured image acquirer that acquires a captured image regarding the work by the worker; and a generator that generates an instruction image, based on the captured image acquired by the captured image acquirer and on the teaching image for the work acquired by the teaching image acquirer, wherein the displayer displays the instruction image generated by the generator on the display unit to display the instruction image further superimposed on the real space.

### TECHNICAL FIELD

The present invention relates to a display system, an information processor, an information processing method, and a program, for displaying in a superimposed manner an instruction image regarding work at a workplace.

### BACKGROUND ART

Patent Literature 1 discloses a technique of supporting work by displaying a guideline for work superimposed on a monitor screen.

### CITATION LIST

### Patent Literature

Patent Literature 1: Japanese Laid-open Patent Publication No. 2008-93813

### SUMMARY OF INVENTION

### Technical Problem

An inexperienced worker has difficulty in determining whether his/her work is accurate properly following a guideline, only by the guideline displayed superimposed on a monitor screen. Besides, when his/her eyes are fixed on the monitor, the inexperienced worker possibly does not pay enough attention to actual work at hand.

Because of retirement of so-called baby-boomers, there is a problem in clearly and correctly handing the skill of skilled workers down to many junior workers. Further, with globalization, there is a problem in making overseas workers perform the work, which has been performed in Japan, without deteriorating quality of the work.

### Solution to Problem

An object of the present invention is to appropriately perform work support for a worker.

### Solution to Problem

Hence, a display system of the present invention includes: a teaching image acquirer that acquires a registered teaching image for work; a displayer that displays the teaching image for the work acquired by the teaching image acquirer on a display unit of a display device worn by a worker who performs the work to display the image for the work superimposed on a real space; a captured image acquirer that acquires a captured image regarding the work by the worker; and a generator that generates an instruction image, based on the captured image acquired by the captured image acquirer and on the teaching image for the work acquired by the teaching image acquirer, wherein the displayer displays the instruction image generated by the generator on the display unit to display the instruction image further superimposed on the real space.

### Advantageous Effects of Invention

According to the present invention, it is possible to appropriately perform work support for a worker.

### BRIEF DESCRIPTION OF DRAWINGS

FIG. 1 is a view illustrating one example of a system configuration of a display system.

FIG. 2 is a diagram illustrating one example of a hardware configuration of a display device.

FIG. 3 is a diagram illustrating one example of a hardware configuration of an information processor.

FIG. 4A is a chart (No. 1) illustrating one example of a teaching image table.

FIG. 4B is a chart (No. 2) illustrating one example of the teaching image table.

FIG. 5 is a sequence chart illustrating one example of information processing of displaying a teaching image and an instruction image of the display system.

FIG. 6 is a sequence chart illustrating one example of information processing of setting the teaching image of the display system.

FIG. 7 is a view illustrating another example of the instruction image.

### DESCRIPTION OF EMBODIMENTS

Hereinafter, an embodiment of the present invention will be described based on the drawings.

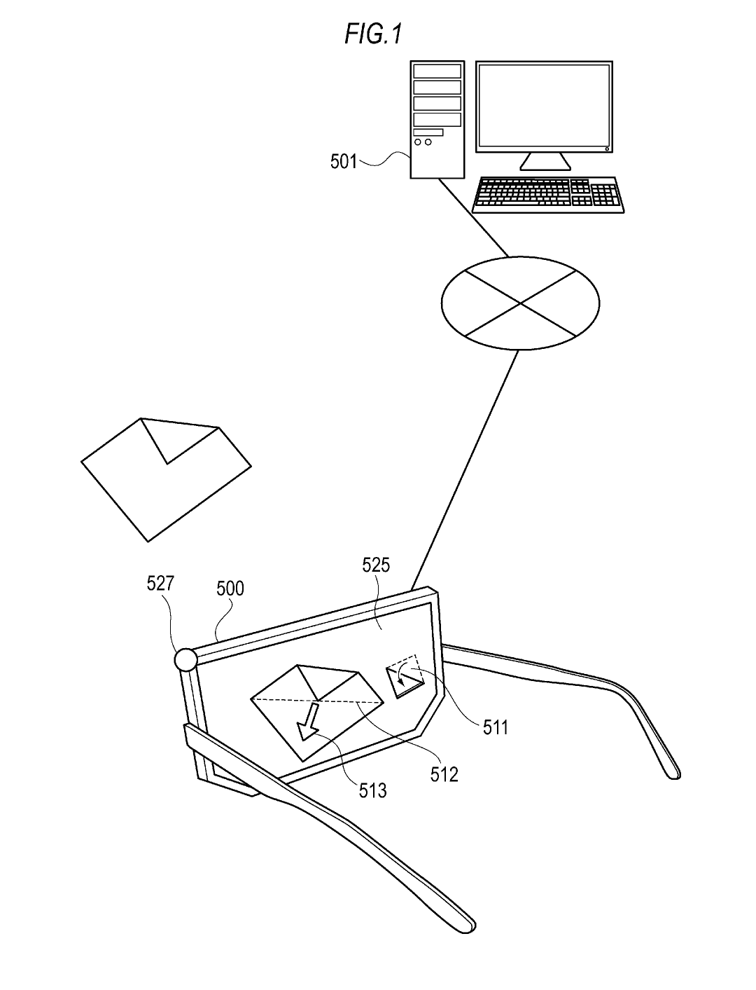

FIG. 1 is a view illustrating one example of a system configuration of a display system. As illustrated in FIG. 1, the display system includes, as the system configuration, a display device 500 and an information processor 501. The display device 500 and the information processor 501 are connected communicably over a network or the like. Although only the display device 500 is connected communicably with the information processor 501 in the example of FIG. 1, a plurality of display devices may be connected communicably with the information processor 501. The information processor 501 is one example of a computer.

The display device 500 is a glasses-type display device worn by a worker. In this embodiment, the worker who is performing work of folding an airbag performs the work while wearing the display device 500.

The display device 500 is an optical see-through display device and has an optical see-through display unit 525 provided at a position corresponding to lens portions of a pair of glasses. The worker wearing the display device 500 can see, through the display unit 525 of the display device 500, an article existing ahead of a line of sight in a real space. Further, an image generated by the information processor 501 is displayed on the display unit 525, so that the worker wearing the display device 500 can recognize a state where the image generated by the information processor 501 is superimposed on the real space which the worker is watching through the display unit 525, namely, an augmented reality space (AR space).

The display device 500 further has an image-capturing unit 527 provided at a position adjacent to the display unit 525. The image-capturing unit 527 is installed so that a direction of the line of sight of the wearer of the display device 500 and an image-capturing direction of the image-capturing unit 527 have a mutually matched relation. This enables the image-capturing unit 527 to capture an image of the work in the real space which the worker wearing the display device 500 is watching. As another example, the image-capturing unit 527 may be set so that the image-capturing direction and the direction of the line of sight of the wearer of the display device 500 have a certain relation.

The information processor 501 acquires a registered teaching image relating to work by a skilled worker and transmits the teaching image to the display device 500, for example, in response to a transmission request from the display device 500.

An image 511 is one example of the teaching image. In the example of FIG. 1, a teaching image indicating a way to fold the airbag is displayed on the display unit 525 of the display device 500.

Further, the information processor 501 compares the captured image captured by the image-capturing unit 527 of the display device 500 with the teaching image, generates an instruction image according to the result of the comparison so as to bring the work by the aforementioned worker closer to the motion indicated by the teaching image, and transmits the instruction image to the display device 500.

A dotted line image 512 and a direction image 513 are examples of the instruction image. In the example of FIG. 1, the dotted line image 512 indicating a right position where the airbag is to be folded and the direction image 513 indicating a folding direction are displayed, as the instruction images, superimposed on the airbag on which the worker is actually performing work, on the display unit 525 of the display device 500. FIG. 1 illustrates an example in which the image 511 being the teaching image is displayed at an upper right of the display unit 525 and the dotted line image 512 and the direction image 513 being the instruction images are displayed superimposed on the actual airbag, for simplifying the description. However, the display system may display the image 511 being the teaching image superimposed on the actual airbag. In addition, in the case where a difference between the teaching image and the image of the actual airbag is a threshold value or more, the display system may display the dotted line image 512 and the direction image 513 being the instruction images superimposed on the actual airbag, while erasing the teaching image displayed superimposed on the actual airbag or while displaying the teaching image together with them.

Evaluation of the difference between the teaching image and the image of the actual airbag is performed using an image processing technique. For example, the similarity between the teaching image and the image of the actual airbag is calculated for comparison. More specifically, the information processor 501 sets in advance the similarity that is an acceptability criterion, and determines to display the above-described instruction images when the difference between the calculated similarity and the similarity of the acceptability criterion is a predetermined value (threshold value) or more. Note that a pattern, design or the like may be printed at a plurality of predetermined positions on cloth for the airbag so as to facilitate extraction of feature points at the time of calculating the similarity.

The comparison between the teaching image and the actual airbag image is performed at predetermined timing. For example, the teaching image for one fold is prepared in advance, and a user instructs the information processor 501 to perform processing of image matching every time the user folds the actual airbag one time. In this event, such a configuration may be employed that when the user produces a sound, for example, “check” by voice, the image-capturing unit 527 captures an actual airbag image and transmits its image data to the information processor 501, and the similarity is calculated by image matching processing with respect to a teaching image at a corresponding timing among teaching images each captured for one fold prepared in advance. As the teaching image, the image in the case where the skilled worker has folded an airbag, equivalent to the actual airbag, used as a sample may be used.

Note that though the teaching image for one fold prepared in advance and the actual airbag image are different in orientation, magnification or the like, the calculation of similarity is enabled by using a template matching technique capable of comparison through rotation or expansion/contraction of the images. However, in the case where the orientations of the images to be compared are opposite to each other, the matching processing requires much time. Therefore, for example, such a configuration may be employed that a teaching image indicating an appropriate image-capturing orientation is displayed before the user produces a sound “check”, and at the time of capturing an image of the airbag during work, the user matches the orientation of the actual airbag with the same orientation as that of the teaching image.

Further, the camera for capturing an image for matching is not limited to the image-capturing unit 527, but a dedicated camera for matching fixed directly above a folding table for the airbag may be provided. In the case of capturing an actual airbag image by the image-capturing unit 527 provided in the display device 500, the accuracy of image matching does not become stable even for the same airbag because the angle for capturing the image is different depending on the posture of the user, but the accuracy of image matching becomes stable by using the fixed dedicated camera. Further, to make the airbag placed on the folding table seen clearly, the folding table may be in black, for example, in the case where the airbag is white.

Incidentally, the determination of similarity is performed as follows. First, the contour of the actual airbag image and the contour of a teaching image corresponding thereto are compared, and position adjustment is performed while correcting the orientations and sizes of the images. For example, a plurality of feature points on the contours are extracted, the similarity between the teaching image and the actual airbag image is calculated for a predetermined region including each of the feature points, and the actual airbag image is rotated or expanded/contracted so that the feature points having a predetermined similarity or more overlap each other, thereby performing position adjustment between the two images. Thus, the overlapping feature points have the same coordinate values on the same coordinate space.

Next, the images which have been subjected to the position adjustment are compared in terms of appearance of the design put on the airbag. In the case where the actual airbag has been folded as in the teaching image, the appearance of the design in the actual airbag image and the appearance of the design in the teaching image coincide with each other. On the other hand, if the ways to fold are slightly different, the appearances of the designs merely partially coincide with each other. Image matching is performed for the appearances of the designs, and the similarity between the teaching image and the actual airbag image is calculated.

Here, when the difference between the calculated similarity and the similarity of the acceptability criterion is the predetermined value (threshold value) or more, the information processor 501 determines that the above-described instruction image needs to be displayed. Meanwhile, the similarity itself may be regarded as the threshold value. More specifically, in the case where the similarity exceeds an acceptability criterion value (threshold value), for example, a display such as “OK” may be made.

Incidentally, generation of the instruction image is performed as follows for instance. First, the contours are compared as described above to perform position adjustment between the two images. Here, since a fold line that is a check point in the teaching image at certain timing for check has been already decided, a fold line corresponding thereto is detected in the actual airbag image by image processing. The fold lines are expressed by line segments on the same coordinate space, and an image of an arrow indicating a direction in which the fold line in the actual airbag image coincides with the fold line in the teaching image according to the angle representing the displacement between the line segments can be displayed on the display device 500.

Alternatively, such a configuration may be employed that the image is divided into regions in predetermined shapes (for example, a lattice form), the similarity between the teaching image and the actual airbag image is calculated for each of the regions, and a message such as “please check sample (teaching image)” is displayed together with an arrow indicating a region having a similarity lower than the predetermined value in the actual airbag image, on the display device 500 without any particular limitation.

By watching the instruction image, the worker can find that the way to fold the airbag is incorrect and intuitively recognize how to fold the airbag.

In short, according to the display system, it is possible to appropriately perform work support for the worker, and accordingly to keep the quality of a product or the like as a result of the work constant and enable succession of the skill in the work by the skilled worker.

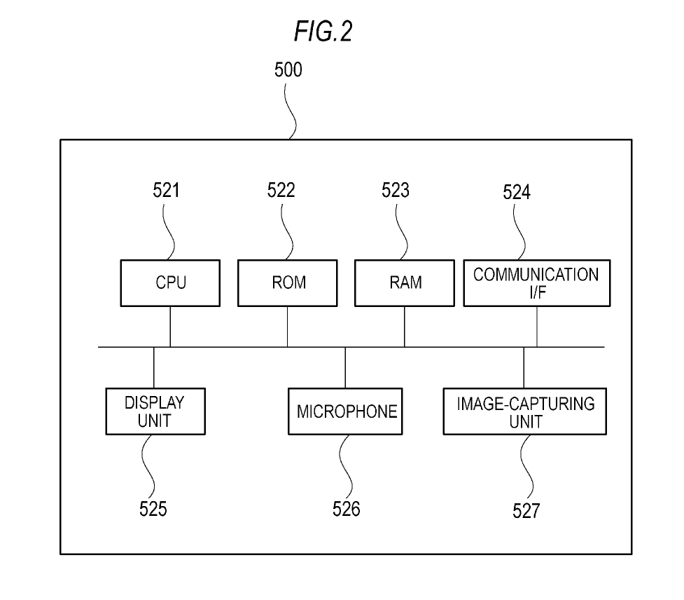

FIG. 2 is a diagram illustrating one example of a hardware configuration of the display device 500. The display device 500 includes, as the hardware configuration, a CPU 521, a ROM 522, a RAM 523, a communication I/F 524, the display unit 525, a microphone 526, and the image-capturing unit 527. The CPU 521 reads a program stored in the ROM 522 and executes various kinds of processing. The RAM 523 is used as a temporary storage area such as a main memory, a work area and the like for the CPU 521. The CPU 521 reads the program stored in the ROM 522 and executes the program, whereby the function of the display device 500 and the processing by the display device 500 in the sequence chart are realized.

The communication I/F 524 performs communication processing with the information processor 501 over the network. The display unit 525 displays various kinds of information. The microphone 526 receives input of voice such as a speech or the like of the worker wearing the display device 500. Note that the voice is sent to the CPU 521 and subjected to voice recognition processing in the CPU 521. The CPU 521 can accept various instructions by the user from the result of the voice recognition. The image-capturing unit 527 takes a picture of the real space. The ROM 522 is one example of a storage medium.

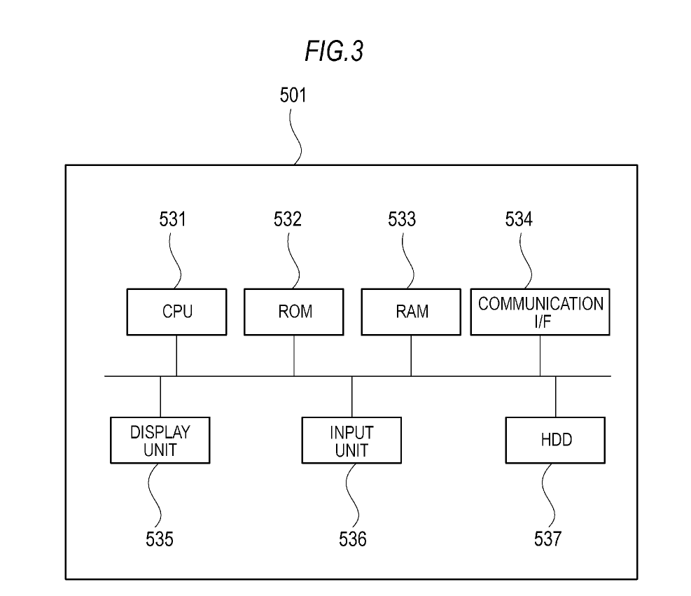

FIG. 3 is a diagram illustrating one example of a hardware configuration of the information processor 501. The information processor 501 includes a CPU 531, a ROM 532, a RAM 533, a communication I/F 534, a display unit 535, an input unit 536, and an HDD 537. The CPU 531, ROM 532, RAM 533, and communication I/F 534 are the same as the CPU 521, ROM 522, RAM 523, and communication I/F 524, respectively. The display unit 535 displays various kinds of information. The input unit 536 includes a keyboard and a mouse, and accepts various operations by the user. The HDD 537 stores data, various programs and so on. The CPU 531 reads a program stored in the ROM 532 or the HDD 537 and executes the program, whereby the function of the information processor 501 and the processing by the information processor 501 in the sequence chart are realized. The ROM 522 or the HDD 537 is one example of a storage medium.

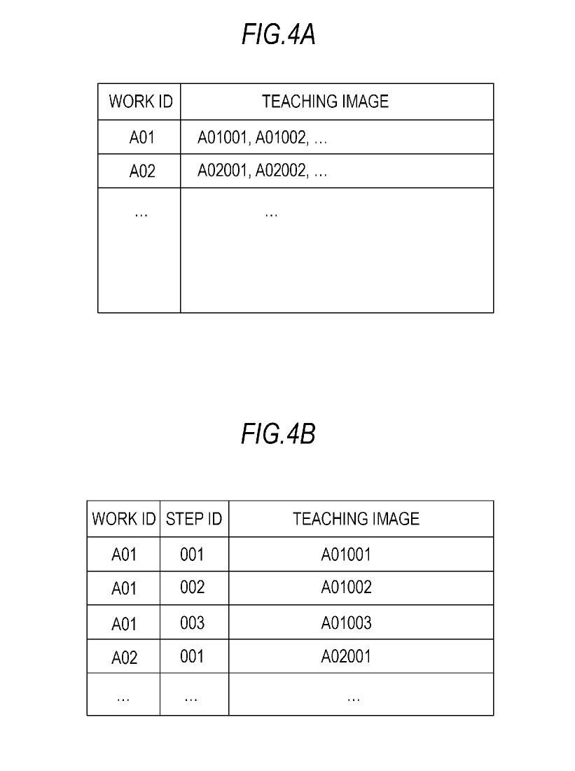

Next, the data that the information processor 501 stores in the HDD 537 and so on will be described using FIG. 4A and FIG. 4B. However, a storage destination where the data is stored is not limited to the HDD 537 but may be a data server or the like on a network with which the information processor 501 is communicable.

A teaching image table illustrated in FIG. 4A includes a work ID and a teaching image for the work corresponding to the work ID. One example of the work is work of folding the airbag unless otherwise stated in the following. However, the work is not limited to the work of folding the airbag, but also includes various works such as work of electric welding, work of vehicle body coating, vehicle assembling work, and bathing care (bathing work), rehabilitation work and so on in care.

In FIG. 4A, the teaching image table has been described assuming that a plurality of teaching images are registered for one work ID. However, as illustrated in FIG. 4B, the teaching image table may include a work ID, a plurality of steps constituting the work identified by the work ID, and a teaching image for the step (for example, one teaching image being the point at the step). Hereinafter, the teaching image table will be described as being configured as in FIG. 4B for simplifying the description. Further, the teaching image will be described as including positional information displayed on the display unit 525 for simplifying the description. In short, the display device 500 displays the teaching image on the display unit 525 on the basis of the positional information included in the teaching image.

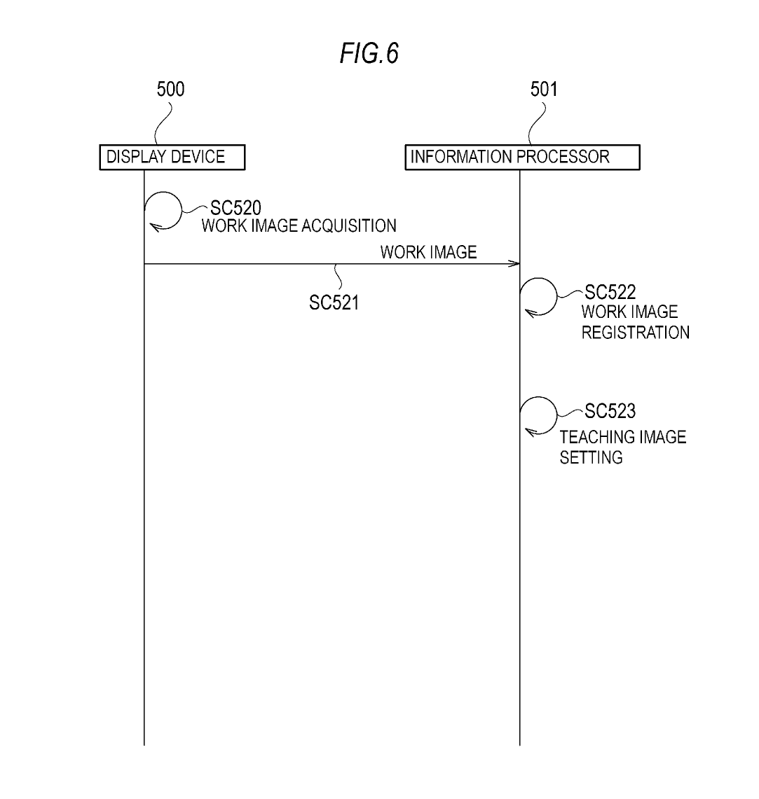

One example of registration (or setting) of the teaching image will be described using later-described FIG. 6.

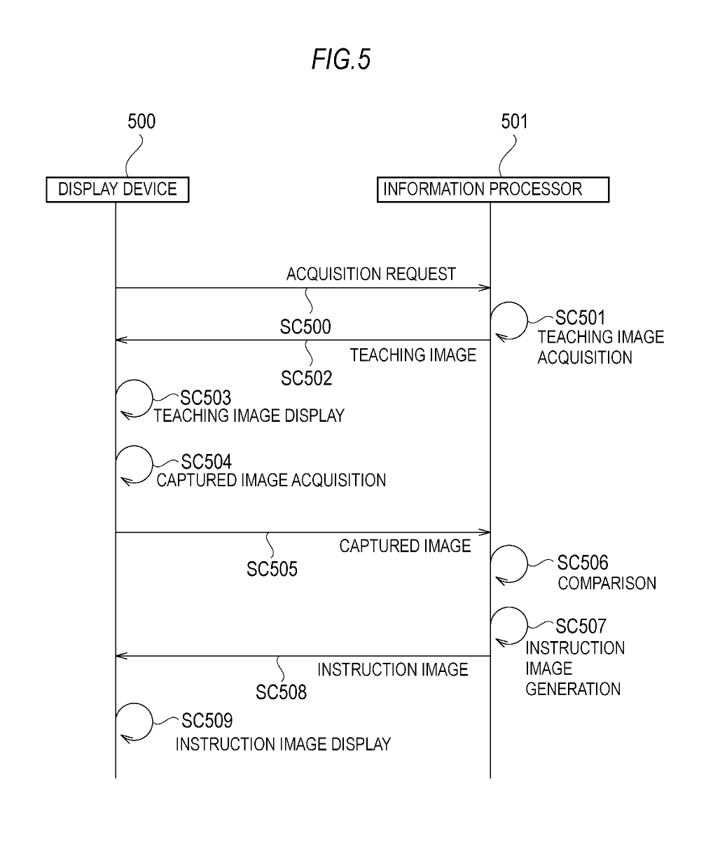

FIG. 5 is a sequence chart illustrating one example of information processing of displaying the teaching image and the instruction image of the display system.

At SC500, the display device 500 transmits an acquisition request for the teaching image to the information processor 501. The display device 500 may specify work that the worker is going to perform from now via voice input by the worker wearing the display device 500, or may specify work set in a setting file in the case where work is set in the setting file or the like in advance in each display device. Further, the display device 500 may specify a step of the work via voice input by the worker wearing the display device 500, or may measure time from start of the work and automatically specify a step of the work based on the measured time. The acquisition request for the teaching image includes a work ID for identifying the work specified by the display device 500 and a step ID for identifying which step of the work.

At SC501, the information processor 501 acquires a teaching image corresponding to the work ID and the step ID from the teaching image table on the basis of the work ID and the step ID included in the acquisition request for the teaching image. The processing at SC501 is one example of processing of teaching image acquisition.

At SC502, the information processor 501 transmits the acquired teaching image to the display device 500 that is the request source.

At SC503, the display device 500 displays the acquired teaching image on the display unit 525. In the case where the positional information included in the teaching image is such positional information that the teaching image is displayed superimposed on the actual airbag, the teaching image is displayed superimposed on the actual airbag in the middle of being folded as a result of the teaching image displayed on the display unit 525 on the basis of the positional information. On the other hand, in the case where the positional information included in the teaching image indicates a predetermined position of the display unit 525 (for example, the upper right as illustrated in FIG. 1), the teaching image is displayed at the predetermined position.

The teaching image being the point at the step of the work performed at present is displayed on the display unit 525, thereby allowing the worker to perform the work while understanding the point at the step of the work.

At SC504, the display device 500 acquires a captured image of the step of the work by the worker via the image-capturing unit 527. The processing at SC504 is one example of processing of captured image acquisition.

At SC505, the display device 500 transmits the acquired captured image to the information processor 501.

At SC506, the information processor 501 compares the received captured image with the teaching image transmitted at SC502.

At SC507, the information processor 501 generates an instruction image according to the result of the comparison. For example, the information processor 501 performs image recognition processing on the captured image and the teaching image, and generates the instruction image when the difference between the images is the set threshold value or more as a result of the image recognition processing, and does not generate the instruction image when the difference is less than the set threshold value. However, this does not limit the embodiment, but the information processor 501 may generate, when the difference is less than the set threshold value, an image indicating that the work is appropriate (for example, an image representing OK or the like) and transmit the image to the display device 500. Further, when the difference is the set threshold value or more, the information processor 501 generates, according to the result of the image recognition processing, for example, the dotted line image 512 indicating the right position where the airbag is to be folded and the direction image 513 indicating the folding direction as the instruction images as illustrated in FIG. 1. For example, the information processor 501 generates, as a result of the image recognition processing, the instruction image including the positional information when the instruction image is displayed, based on the position or the like of the article (the airbag in the example of this embodiment) being the target of the work included in the captured image with respect to the whole captured image.

At SC508, the information processor 501 transmits the generated instruction image to the display device 500 which has transmitted the captured image at SC505.

At SC509, the information processor 501 displays the received instruction image on the display unit 525 on the basis of the positional information included in the instruction image.

FIG. 6 is a sequence chart illustrating one example of information processing of setting the teaching image of the display system.

In the processing described below, the display device 500 is worn by the skilled worker according to work.

At SC520, the display device 500 acquires work images at steps of the work by the skilled worker via the image-capturing unit 527.

At SC521, the display device 500 transmits the acquired work images to the information processor 501.

At SC522, the information processor 501 stores the received work images in the HDD 537 or the like to thereby register the work images.

At SC523, the information processor 501 sets the teaching images being the points at the steps in the work among the registered work images, for example, according to a setting operation by an operator via the input unit 536. The information processor 501 generates the teaching image table as illustrated in FIG. 4B according to the above-described setting or the like.

In the above-described example, the example in which the information processor 501 selects the image being the teaching image among the plurality of work images has been described. However, the display device 500 may select the image being the teaching image among the plurality of work images and transmit the select image to the information processor 501. In this case, the information processor 501 generates the teaching image table as illustrated in FIG. 4B on the basis of the received teaching image or the like. In this case, the skilled worker wearing the display device 500 may input the fact that the teaching image indicates which step of which work into the display device 500 via voice or the like, or the operator of the information processor 501 may input or designate the fact that the teaching image indicates which step of which work via the input unit 536 or the like.

### Modified Example

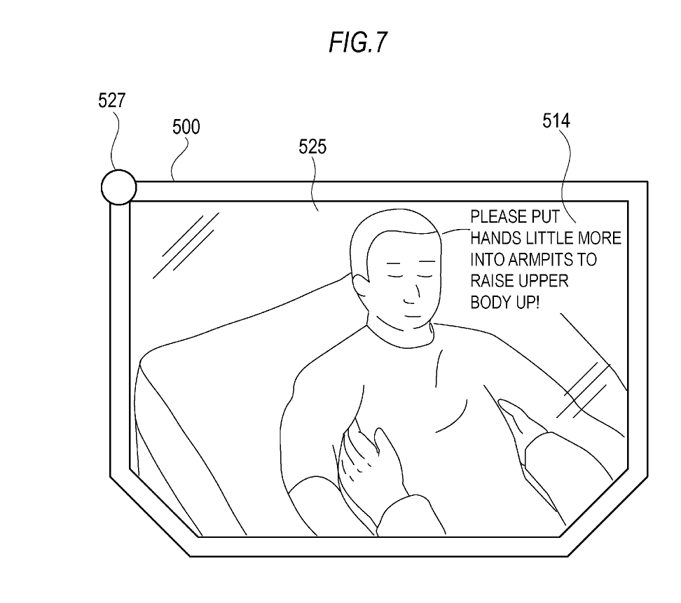

FIG. 7 is a view illustrating another example of the instruction image.

FIG. 1 and so on above-described illustrate the example in which the information processor 501 generates the dotted line image 512 indicating the right position where the airbag is to be folded and the direction image 513 indicating the folding direction are displayed as the instruction images, taking the work of folding the airbag as an example, and the display device 500 displays the images.

However, the work is not limited to the work of folding the airbag as described above. FIG. 7 illustrates one example of the instruction image in the case of bathing care as one example of the work.

In the case where the work is the bathing care and its first step is getting-up assistance, the information processor 501 transmits a teaching image being a point of the getting-up assistance to the display device 500. Then, upon reception of a captured image from the display device 500, the information processor 501 performs image recognition processing on the captured image and the teaching image, and generates an instruction image when the difference between the images is the set threshold value or more as a result of the image recognition processing.

In other words, in the example of FIG. 7, the information processor 501 generates an instruction image illustrated in an image 514 from the teaching image and a captured image of the actual work by the worker. The information processor 501 then transmits the generated instruction image to the display device 500.

The display device 500 displays the received instruction image on the display unit 525 on the basis of the positional information included in the received instruction image.

More concrete description of the configuration of care support is as follows. First, a care receiver puts on a dedicated shirt with markers. The markers are put, for example, on portions corresponding to the armpits, shoulders, waist, or other portions such as the chest, belly or the like. Note that the shirt with markers may be prepared in a plurality of sizes according to the builds of care receivers.

For example, in the case of the above-described getting-up assistance, a care giver needs to place hands at the armpits in a manner to hide the markers put thereon. The marker is put on a predetermined range of the armpit, so that if the hand is not appropriately placed, the marker comes to protrude in a wide range. Hence, the information processor 501 may detect the protruding amount of the marker in the image captured by the image-capturing unit 527 and, when a predetermined amount or more of the marker protrudes, generate an instruction image of “Please check the way to place a hand.” and transmit the image to the display device 500. Upon reception of the instruction image, the display device 500 displays the instruction image.

Alternatively, the information processor 501 may perform image matching processing, regarding the protruding degree of the marker, between a teaching image by a skilled care giver and an actual care image at the same timing, and generate an instruction image according to an analysis result thereof. For example, the information processor 501 can also be configured to divide an image around the armpit into a plurality of regions and detect the protruding amount of the marker for each of the regions. This makes it possible to detect a region with a low protruding degree and a region with a high protruding degree through comparison with the teaching image, thereby enabling instruction of a direction, angle or the like for a hand to place, so as to make the protruding degrees uniform (so as to make the protruding amounts in the regions uniform).

Note that such a configuration may be employed that teaching images by skilled care givers of a plurality of body types (body height, body weight, size of hand and so on) are prepared in advance so that at the time of displaying a teaching image, the teaching image by the skilled care giver of a body type close to that of a trainee care giver in care training is displayed. This configuration can be employed to reduce the influence due to the different in protruding degree of the marker caused from the difference in build.

Besides, the marker is not limited to the one put to the position at which the hand is placed. For example, there is such a possibility that the quality of the care work varies due to the difference between the eye line of the skilled care giver and the eye line of an inexperienced care giver. In this case, a plurality of small point-like markers are put in advance at a plurality of positions corresponding to the chest and the bully so that the information processor 501 can determine the propriety of the line of sight of the care giver on the basis of the plurality of markers in a captured image.

More specifically, the information processor 501 determines whether or not the positions of the markers put on the shirt of the care receiver are appropriate in the image captured by the image-capturing unit 527. For example, the information processor 501 divides the captured image into a plurality of regions (a lattice form or the like), and determines whether or not each of the markers put on the positions corresponding to the chest and the bully is located in a predetermined region. The information processor 501 can determine whether or not the marker is located in the predetermined region, for example, by comparison with the teaching image by the skilled care giver and on the basis of the similarity between the images in each region and the numbers of markers included therein. More specifically, in the case where the markers included in the teaching image by the skilled care giver in a certain region are not included in the captured image during work by the trainee care giver or the markers, if included, are less in number than a set number, the lines of sight can be considered to deviate from each other. Then, the information processor 501 analyzes markers included in each region and thereby becomes possible to instruct the care giver during work to have the orientation of the eye line so as to make the markers included in the teaching image and in the actual care image coincide with each other.

A preferred embodiment has been described in detail in the above, but the present invention is not limited to the specific embodiment.

For example, the display system generates the teaching image and the instruction image using the image recognition technique and displays the images on the display device 500 in the above-described embodiment. However, markers may be put on a workplace or the like and the image-capturing unit 527 may capture an image in a manner to include the markers. Then, the display system may display the teaching image and the instruction image using the markers for position adjustment.

According to the above-described embodiment, it is possible to appropriately perform work support for the worker. As a result, it is possible to keep the quality of a product, service or the like as a result of the work constant and enable succession of the skill in the work by the skilled worker.

Further, according to the processing in the above-described embodiment, the teaching image and the instruction image for work can be displayed superimposed on the real space by simple information processing in the display system, resulting in a reduction in amount of communication between the display device 500 and the information processor 501. Therefore, the usage rate of a band of the network can be decreased. Further, the teaching image and the instruction image for work can be displayed superimposed on the real space by simpler information processing on the display system 500, resulting in a reduction in usage rate of the CPU 521 or the like of the display device 500. This also applies to the information processor 501.

1. A display system comprising:
a teaching image acquirer that acquires a registered teaching image for work;
a displayer that displays the teaching image for the work acquired by the teaching image acquirer on a display unit of a display device worn by a worker who performs the work to display the teaching image for the work superimposed on a real space;
a captured image acquirer that acquires a captured image regarding the work by the worker; and
a generator that generates an instruction image, based on the captured image acquired by the captured image acquirer and on the teaching image for the work acquired by the teaching image acquirer,
wherein the displayer displays the instruction image generated by the generator on the display unit to display the instruction image further superimposed on the real space.

2. The display system according to claim 1, further comprising:
a register that registers work images of work; and
a setter that sets a teaching image among the work images registered by the register.

3. An information processor comprising:
a teaching image acquirer that acquires a registered teaching image for work;
a generator that generates an instruction image, based on a captured image acquired by a display device communicable with the information processor over a network and on the teaching image for the work acquired by the teaching image acquirer; and
a transmitter that transmits the instruction image generated by the generator to the display device.

4. An information processing method executed by an information processor, the information processing, method comprising:
a teaching image acquisition step of acquiring a registered teaching image for work;
a generation step of generating an instruction image, based on a captured image acquired by a display device communicable with the information processor over a network and on the teaching image for the work acquired by the teaching image acquisition step; and
a transmission step of transmitting the instruction image generated by the generation step to the display device.

5. An information processing method executed by a display system, the information processing method comprising:
a teaching image acquisition step of acquiring a registered teaching image for work;
a first display step of displaying the teaching image for the work acquired by the teaching image acquisition step on a display unit of a display device worn by a worker who performs the work to display the teaching image for the work superimposed on a real space;
a captured image acquisition step of acquiring a captured image regarding the work by the worker;
a generation step of generating an instruction image, based on the captured image acquired by the captured image acquisition step and on the teaching image for the work acquired by the teaching image acquisition step; and
a second display step of displaying the instruction image generated by the generation step on the display unit to display the instruction image further superimposed on the real space.

6. A non-transitory computer-readable recording medium recording a program to cause a computer to execute:
a teaching image acquisition step of acquiring a registered teaching image for work;
a generation step of generating an instruction image, based on a captured image acquired by a display device communicable with the computer over a network and on the teaching image for the work acquired by the teaching image acquisition step, and
a transmission step of transmitting the instruction image generated by the generation step to the display device.
